(19) United States
(12) Patent Application Publication
(10) Pub. No.: US 2003/0178411 A1
(43) Pub. Date: Sep. 25, 2003

(54) Food steamer with automatic electric steam trap, power modulation and automatic connected water supply

(76) Inventors: Mark Manganiello, Everett, MA (US); Peter Castrichini, Peabody, MA (US); Mark J. Doran, Providence, RI (US)

Correspondence Address: EDWARDS & ANGELL, LLP, P.O. BOX 9169, BOSTON, MA, 02209, US

(21) Appl. No.: 10/253,127

(22) Filed: Sep. 24, 2002

Related U.S. Application Data
(63) Continuation-in-part of application No. 10/105,179, filed on Mar. 25, 2002, now Pat. No. 6,453,802.

(51) Int. Cl. A21B 1/22; H05B 1/02; F27D 11/00

(52) U.S. Cl. 219/496; 219/401; 219/494

(57) ABSTRACT

A steam cooker has an insulated housing that surrounds an internal cooking compartment accessible through a door. In one form, a supply of water is held in the compartment and immerses a plate-like resistance heating element mounted at the floor. Water is automatically added to this supply when both 1) a water level sensor indicates a refill, and 2) a door switch signals that the door is open. these signals together open a normally-closed solenoid valve in a water feed line. A steam outlet located above the maximum water level is in fluid communication with and adjacent another electrically-operated solenoid valve that is normally open to atmosphere. In one mode of operation, a temperature sensor in close physical proximity to the steam outlet and the solenoid valve closes the solenoid wherein the sensed steam temperature is at or above a set level. The outlet steam is also connected to a pair of water column pressure-responsive microswitches that control power to the heating element and, if there is an over-pressure, to open the solenoid valve to vent the steam to atmosphere. Plural such steam cookers can operate in parallel stacked in a single cabinet, and each capable of operating in a fast cook mode where the water and power savings advantages of the electric steam trap are disabled or adjusted.

### REFERENCE TO RELATED APPLICATION

This is a continuation-in-part of U.S. application Ser. No. 10/105,179 filed Mar. 25, 2002 for “Connectionless Food Steamer With Automatic Electric Steam Trap, now U.S. Pat. No. 6,453,892 issued on Sep. 24, 2002.

### BACKGROUND OF THE INVENTION

The present invention relates to a steam cooking apparatus and methods and in particular to a steam cooker with one or more ovens each with an automatic cold air and steam outlet; close pressure control to enhance the efficiency of the cooker; and an automatic, visible refill of the water supply of a generator.

A wide variety of steam cookers are known. Market Forge Industries, Inc., the present assignee, manufactures a wide variety of steam cookers and food warmers that have found wide acceptance in the food service industry as a way to rapidly cook food, including frozen food, and/or maintain it at a serving temperature. While pressure cookers have long been used in homes and restaurants, the risks and extra costs of containing steam under high pressure have led to the growth of slow steam cookers that use steam to deliver heat to the food, but at a pressure that is typically just above atmosphere (1 to 2 inches of water). Most conventional atmospheric (or “pressureless”) steam cookers have steam generators, typically ones external to the cooking compartment and using electrical resistance or gas heaters that produce steam from a water supply.

U.S. Pat. Nos. 5,549,038 and 5,631,033 to Kolvites and assigned to Market Forge Industries describe one implementation of a commercial steam cooker sold under the trade designation “STEAM TECH PLUS®”. The Kolvites cooker has permanent connections to a water supply and a drain. It can continuously replenish the supply of cold water in its generator. Periodically, on demand, it can draw water (e.g. at a rate of 30 gallons per hour (gph)) from the supply, heat the water to produce steam, circulate the steam in an oven chamber around the food to cook it and/or keep it warm until served, and then direct the steam and condensed water to the drain.

While such units offer many advantages, such as rapid, efficient cooking of large volumes of food, including frozen food, their disadvantages include a relatively large water usage, attendant high power requirements to heat the water, and burdensome maintenance requirements such as daily, monthly and annual cleanings to remove scaling (“deliming”) on heating coils, tubes and other components produced by the boiling, as well as to remove residue from the cooking process itself These units are typically large and comparatively complex in their construction. They also are constrained in that a flow of steam is condensed to hot water that must usually be cooled before it can be drained into public sewer systems. Hot water can, for example, degrade PVC piping and destroy necessary bacteria in septic systems and leeching fields.

Another type of steam cooker, commonly termed “connectionless”, avoids some of these constraints of connected cookers. Connectionless cookers, as the term suggests, do not have permanent connection to a water supply. Rather, water is added manually to the unit. It is evaporated, condensed, collected, and reused. This type of steamer can operate for comparatively long periods of time without adding additional water, and with significantly reduced water and power usage as compared to the connected steam cookers because cold water is not added on demand to form the steam, and then drained after use. An earlier steamer sold by Market Forge Industries, Inc. under the trade designation “STEAM IT®” is connectionless and holds a supply of water within its heating compartment. In general, connectionless steamers cook smaller quantities of food than connected ones, but are easier to maintain, more portable, and cost less to operate.

Steam cookers of both types—connected and connectionless—use a door to gain access to the cooking compartment to add and remove the food, typically food held in one or more pans that slide onto racks mounted on the side walls of the cooking compartment. The opening and closing of this door produce a loss of steam, fluctuations in steam pressure, and introduce cold air into the compartment. The efficiency and the quality of operation of the steam cooker is dependent upon the degree to which the temperature and pressure of the steam within the cavity can be maintained at or near a preselected optimal value, or within an optimal range of values.

It is also important in all steamers to have reliable and effective controls to prevent burnout of the heater, typically caused by a low water condition. In connectionless steamers, a critical low water situation typically develops as steam is lost from the cooking compartment, and more water is boiled to replace it. (There is usually loss at least when the door is opened, and via a bleed orifice used to introduce some flow in the steam to keep it “active”.) Eventually the water supply is depleted, causing the electric resistance heating element to overheat.

Known steamers have water level detection arrangements, but they can fail. One particular problem with connectionless steamers is that certain foods when steam cooked release materials to the steam which collect in the condensed water and create a layer of foam on the water. This foam can interfere with the operation of the water level detectors, causing the heating element to overheat to the degree that causes permanent damage. Another problem with certain known steamers is that scaling (mineral deposits) produced by evaporation of the water, as well as the accumulation of residue from the cooking process, can be carried by fluids and interfere with the operation movement of moving components used to control the cooking process.

Another problem with steamers—and particularly connectionless steamers that are inherently closed systems—is that on start-up, or after the door is opened during cooking, cold air is trapped in the cooking compartment. The cold air takes heat energy from the cooking and makes the heat gradient and cooking rate within the over uneven. While mechanical steam vents, bleed orifices, check valves, and the like have been used, the rapid and controlled elimination of trapped cold air from the cooking compartment, without also losing any significant volume of steam, remains a problem.

The amount of heat produced by a steam cooker also must accommodate variations in the quantity of food, its temperature, and its surface area. A small amount of room temperature food will be cooked quickly with the steam generator powered. Continued heating will generate a dangerous overpressure and overcook the food. Various arrangements have therefore been employed to apply electrical power to a heater of a steam generator intermittently, as needed. The aforementioned Kolvites '038 and '033 patents, for example, use a pressure-sensitive switch connected in series in the power supply line. The switch responds to the steam pressure in a long outlet conduit from the oven to modulate the power supplied to make steam. To control a possible dangerous outrush of steam when the oven door is opened, Kolvites provides a switch responsive to an opening of the door that opens a valve in a fresh water supply line. The resulting cold water flow quenches steam in the steam generator and also cools a mechanical steam trap to open the steam outlet line to atmosphere. An open door switch also blocks any power to the generator.

In connectionless steamers, Creamer et al, U.S. Pat. No. 5,869,812 disclosed a float switch that controls the application of power to a heater mounted under the floor of a heating chamber, adjacent a pool of water. The float switch operates by balancing atmospheric pressure on a supply of water in a reservoir external to the steam housing against the steam pressure in the cooker carried by a conduit from an upper portion of the chamber to the float switch. Depending on how this balance is struck, power to the heater is on or off. Creamer et al. slope the floor of the heating chamber to one corner to facilitate drainage of the pool of water held there. Outlet steam is condensed and cooled in the reservoir, and then gravity recirculated by a conduit back to the water pool within the heating chamber.

In U.S. Pat. Nos. 6,175,100 and 6,107,605, Creamer et al. propose a solution to the problem of cold air trapped in the connectionless cooler of the '812 patent. They place a small hole (bleed orifice) in the steam outlet conduit leading to the float valve. The hole is continuously open to atmosphere. Cold air may escape, as may steam.

While the low water and power usage of connectionless steamers, as well as their compact size and ease of installation are viewed favorably, it has been found that operators are not reliable in monitoring the water supply and adding water, and, in any event, find it inconvenient to add water. Automatic water fill arrangements using level sensors to control the supply of water via a permanent connection are known. This re-supply can occur at any time while the steamer is in use. However, these known arrangements typically add water to a generator or boiler that is external to the cooking compartment, not to a water supply directly in the cooking chamber. One reason is that the addition of any significant amount of cold water to the cooking chamber will cause significant drops in the steam temperature and pressure. In modern steamers where the heater operation is modulated in response to the steam pressure, this addition of comparatively cold water also increases the power usage since the refilled generator or boiler must be brought back to a boil quickly to maintain the efficiency and quality of the steam cooker operation.

Another concern with automatic refill systems used in conjunction with an “internal” (in the cooking compartment) generator is the adverse effect of food debris, cooking by-products, oils, foams, scale, steam and temperature cycling on the operation of the refill. Debris, scale, foam, oils, etc. are a particular problem if the steam cooker does not receive proper cleaning and maintenance. Flow lines and drains can become clogged or blocked. Moving parts, e.g. in float switches, can “stick” or otherwise not operate as intended. Passive and moving parts can wear or degrade.

A further concern is that known connected steamers are characterized by water and power rates that are much higher than those characteristic of connectionless steamers. As noted above, the Kolvites connected steamer typically uses cold water at a rate near 30 gallons per hour to replenish the water supply of the boiler. However, it also cools used steam that has condensed to water to 140° F. or less before it is emptied to public sewers, and it is used to spray the generator when the door is opened to control a hazardous blow-out of steam into the face of the operator. Heretofore, the water and power conservation advantages of connectionless food steamers have been diametrically opposed to the high water usage of connected steamers.

It is therefore a principal object of this invention to provide a hybrid steamer that combines the water and power conservation and other advantages of a connectionless steamer with the convenience of automatic water level maintenance provided by a connected steamer.

Another principal object is to provide these advantages while also providing a close control over the steam temperature and pressure during cooking and following warming.

Still another object is to provide these advantages while also providing the reliability and safety of operation derived from a convenient visual observation of the water resupply and water level.

A further object is to provide the foregoing advantages with rugged, reliable systems that require few controls and a comparatively low level of skill and attention by an operator.

Still another object is to provide a steamer with the foregoing advantages that can be operated in multiple modes and with a wide range of foods, frozen or unfrozen, and in a wide range of quantity.

A further object is to provide a steamer with the foregoing advantages that has multiple cooking compartments for increased cooking capacity and flexibility.

Yet another object of the present invention to provide a steam cooker that eliminates trapped cold air rapidly from the steamer while at the same time conserving water and steam.

### SUMMARY OF THE INVENTION

A steam cooker according to the present invention has a housing with insulated bottom, top and side inner and outer walls that define a cooking compartment or oven within the inner walls. In one preferred form, the floor of the oven and adjacent portions of the side walls hold a supply of water. A heater, in one form a plate-like assembly of cast metal with electrical heating elements embedded therein, is secured at the floor of the housing in a water well. The heater is in direct contact with the water for efficient heat transfer. Operation of the heater generates steam that circulates through the oven, thus providing a generator internal to the steam cooker, in the cooking compartment.

A steam outlet is formed in a wall of the housing (e.g., a back wall of a cooking compartment) and in a lower half of the cooking compartment. In one form, it is located preferably immediately above the high water level in the cooking compartment so that steam generation drives cold air down to this outlet. An electrically-operated solenoid valve is connected substantially directly to the steam outlet via a branched outlet conduit. One branch leads to the solenoid valve and the other branch leads to a pressure regulation/power control system.

The solenoid valve is normally open to atmosphere. A thermostat that senses the temperature of the steam in the heating chamber is located adjacent the steam outlet, also just above the high water line. The thermostat is closely controlled to produce an output control signal when the sensed temperature is at or above a preselected set point, typically just under the boiling point of the water. This output signal closes the solenoid valve to block any significant loss of steam to the atmosphere while directing the outlet vapor via conduits to a set of pressure-sensitive microswitches. The thermostat and solenoid valve so located and so connected constitute an automatic electric steam trap that also provides a ready path to eliminate cold air from the steamer. It is also rapidly and accurately responsive to the temperature of the steam in the heating compartment, e.g., that it is 205 to 210° F. in the cooking compartment.

The second branch conduit from the steam outlet can be a single conduit that itself branches into two conduits. One branch directs the outlet vapor to a first or operating microswitch that cycles between “ON” and “OFF” states as sensed pressure moves between lower and upper preselected set pressure values, typical ones being 1 and 3 inches of water column pressure (“W.C.”), the normal operating range during cooking. When the steamer is started, power is supplied through a preheat stage until it generates steam, and the steam fills the cooking compartment at the preselected operating pressure. As the sensed pressure rises to the upper limit, the first switch interrupts the supply of electrical power to the heater. As the steam then cools, the pressure falls until the falling pressure trips the lower limit of the first switch to supply power again.

The other branch conduit directs outlet steam vapor from the steam outlet to a second pressure-sensitive microswitch that is set to open the solenoid valve on rise at a pressure valve above an upper limit. For an upper limit of 3 inches W.C. at the first operating switch, a typical value of the set limit point of the second switch is 9 inches W.C. This second conduit branch and second switch is a safety feature to release steam if the pressure in the cavity exceeds a safe pressure relief. If this arrangement should fail, a check valve separate from the solenoid valve and in the second branch line from the steam outlet opens to release steam from the steam outlet to atmosphere.

The plate-like heating element is tilted with respect to the horizontal (defined by the water level). This tilt is preferably along a diagonal of a rectangular plate heater so that one corner is elevated slightly with respect to the other corner. Heat sensors, are mounted on these raised and lowered portions of the heater to produce signals indicative first of a low water condition, and then of a more extreme low water condition that turns off the power, and must be manually reset.

The power controls include a two-level power supply selector switch. In one position, the system supplies full power to the heating element, and in the second position supplies a reduced power, e.g., 6 KW reduced to 4 KW for a three-pan sized cooking compartment.

Another important feature of the present invention is an apparatus and method for adding water to the internal generator. A water fill line is connected to a water supply. A servo-controlled valve in the fill line opens to feed water to the generator. Controls for the valve include a first signal indicative of the condition of the steamer door, and a second signal indicative of a lower water level. Preferably, a microswitch or magnetic switch on the door produces a “door open/closed” signal, and a float switch, preferably one mounted external to the steamer housing, produces a signal or signals indicative of the water level. The sensors on the tilted plate heater also sense the water level, but they act more as an extreme limit sensor that protect the heater than water-fill sensors. The door signal must correspond to a “door open” condition for the valve to open. The float switch preferably has a lower limit which produces a “fill” signal that opens the valve and a “full” signal that closes the valve when the water level reaches a preselected maximum value. Thus, water is added only when the door is open and the supply is below a preselected “ADD” level. Operation of the water feed can also be conditioned on a third input signal that the main power switch is “ON”, indicating that the steamer is in use.

In typical operation, the operator turns on the power, and opens the door to insert pans of food to be cooked. The door switch indicates an open position, which allows the water supply line to add water to the generator if the water level is low. Because the door is open and both the water supply and the input end of the water supply line are directly visible to the operator, he can make an independent confirmation of the water level and the successful operation of the water fill system. When the refill stops, the operator closes the door and initiates the cooking in a selected mode of operation, e.g. “fast cook”, “energy saver”, or “warm”.

While the door is closed, water cannot be automatically added. However, at this point the cooking compartment operates with the water and energy saving advantages of a connectionless steamer. Several hours of cooking and warming can occur without requiring that any water be added. Also, in typical operation, the operator will open the door to inspect, stir, or remove one or more pans well before the water supply reaches an extreme low level. During this period, because no “cold” water is added into the heating chamber, the electric steam trap system operates to eliminate the initial supply of cold air in the chamber after the door is closed, and then operates to modulate the supply of power to the cooker, as well as providing venting, drain and over-pressure protection. If the water level falls to a level where water is required, the float switch and/or heater sensors generate warning signals to the operator to open the door for a refill.

The invention also includes a multiple oven steam cooker where each oven can be of the type described above, and, optionally, can be operated with a common water-management or tempering tank located below the ovens. Steam and condensed water from the ovens is drained to the management tank that holds a separate supply of water. This water supply acts as a heat sink to cool the overflow to a temperature below regulatory limits (e.g. 140° F.), before it is released to a public sewer line or an equivalent.

Features of the invention can also be used with an external steam generator, e.g., with pressure regulation and safety release provided by the steam trap system connected to a lower portion of the cooking compartment, but not necessarily just above the water level in the exterior generator. Also, the automatic water-fill system can be used with exterior generators or boilers, and independently of the electric steam trap system.

These and other features and objects of the present invention will be better understood from the following detailed description of the invention which should be read in light of the accompanying drawings.

### DETAILED DESCRIPTION OF THE DRAWINGS

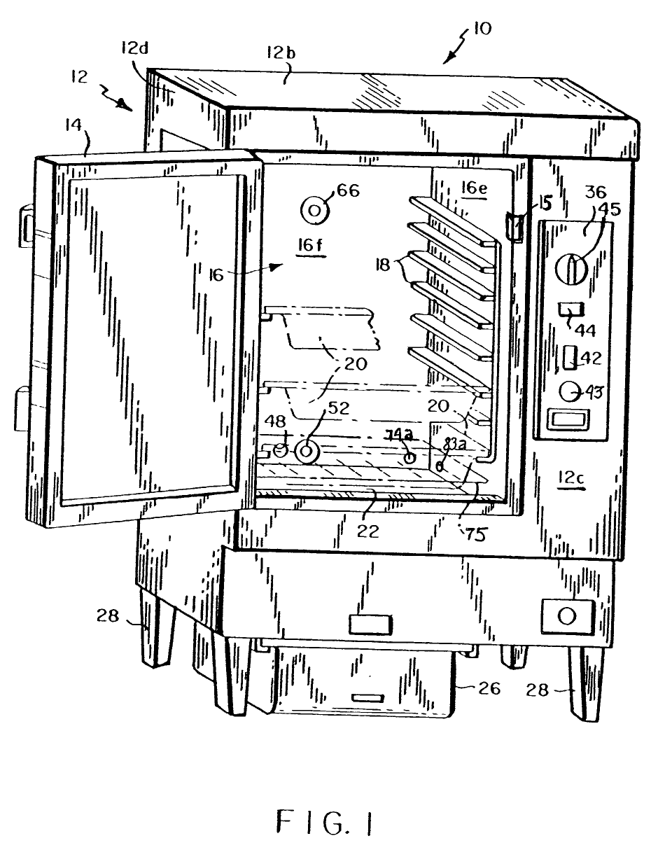

FIG. 1 is a view in perspective of a slow steam cooker according to the present invention with the door open and with pans in the cooking compartment;

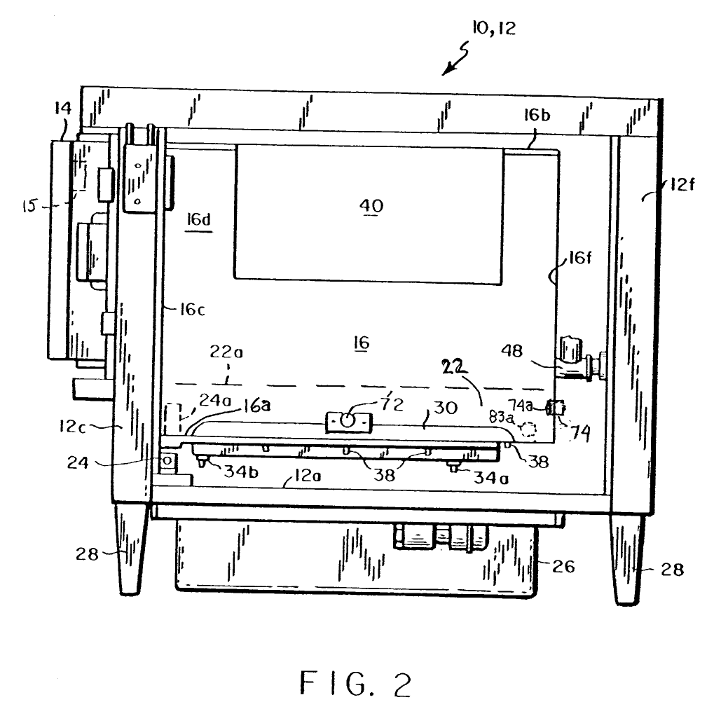

FIG. 2 is a side view in side elevation of the steam cooker shown in FIG. 1;

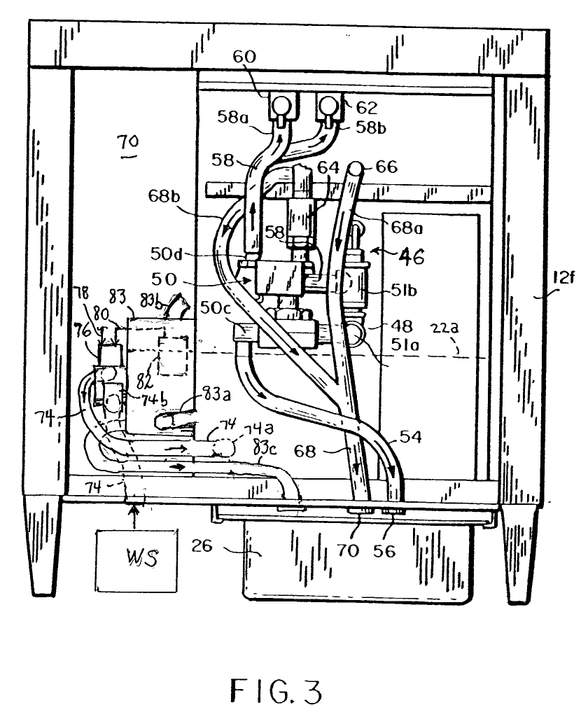

FIG. 3 is a view in rear elevation of the cooker shown in FIGS. 1 and 2;

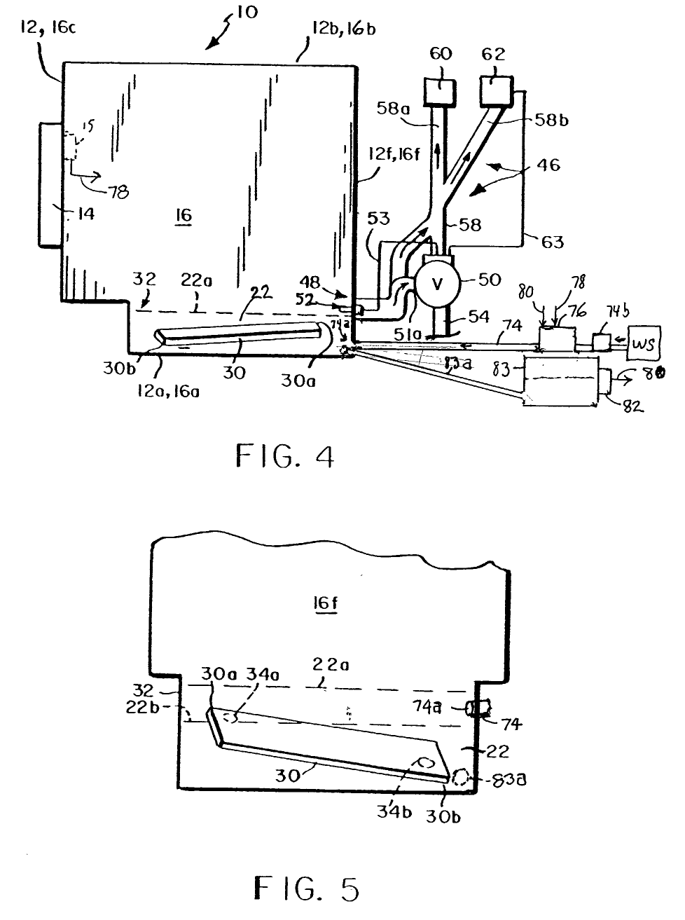

FIG. 4 is a schematic view in side elevation of the steam cooker shown in FIGS. 1-3;

FIG. 5 is a detailed view in front elevation and partially in section of the heating element shown in FIGS. 1-4;

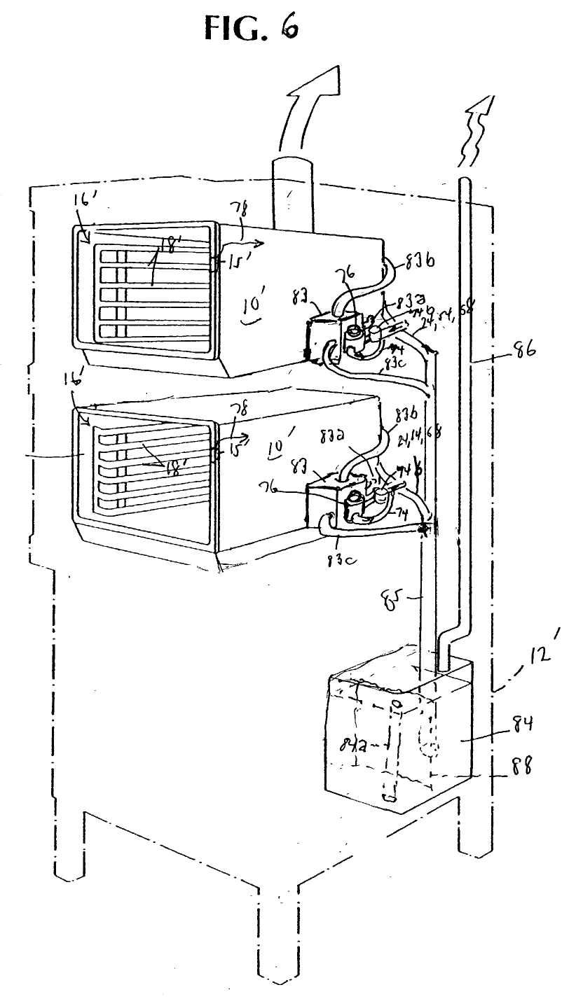

FIG. 6 is a simplified view, in perspective, of a high capacity, multiple oven slow steam cooker according to the present invention; and

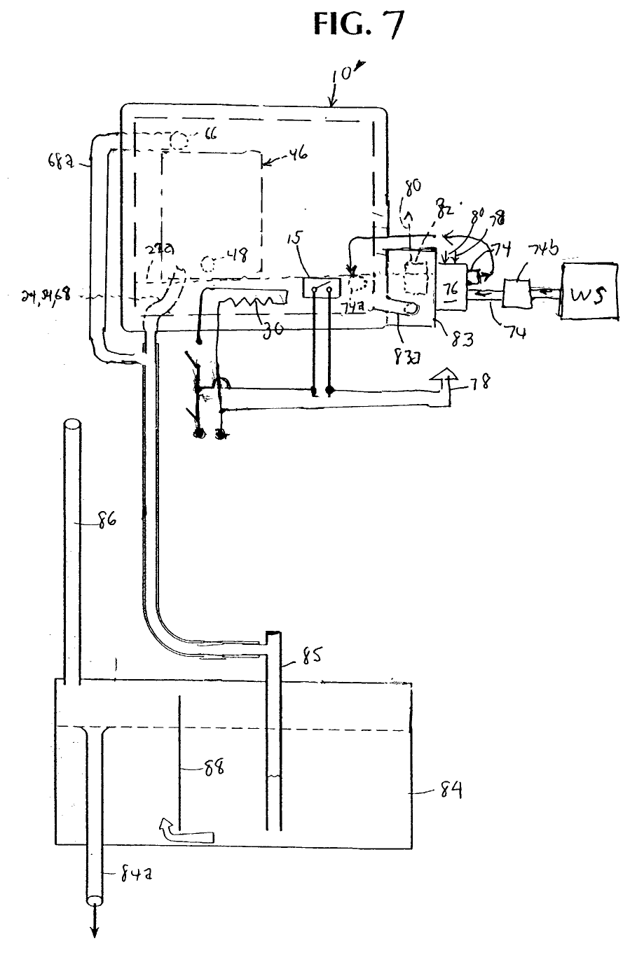

FIG. 7 is a schematic view of one oven of the multiple oven steamer shown in FIG. 6 and the associated water management tank.

### DETAILED DESCRIPTION OF THE INVENTION

FIGS. 1-5 illustrate one embodiment of a atmospheric steam cooker 10 according to the present invention. The cooker includes a generally rectangular outer housing 12 formed principally of stainless steel having a floor 12a, a top wall 12b, and four side walls 12c, d, e, and f. Wall 12f is the back wall of the unit; wall 12c is the front wall that mounts a door 14. As is best seen in FIGS. 2 and 3, the housing encloses a cooking compartment 16 of generally rectangular internal configuration. The inner walls 16a-f (each adjacent and generally parallel to an outer wall 12a-f with the same alphabetical reference) that define the cooking compartment are preferably insulated to retain heat and lower the energy costs for cooking. As shown in FIG. 1, the side interior walls of the cooking cavity contain a series of racks 18 which slideably receive the side edges or flanges on a set of cooking pans 20 that carry food to be cooked in the compartment 16.

The lowermost portion of the cooking compartment 16 is recessed below the lower edge of the door opening to provide a water well 32 for a supply of water 22 for an “internal” (in cooking chamber) steam generator. An internal drain 24 provides a convenient vehicle for emptying water from the cavity. In normal operation, however, excess water that will not exit via drain 24, will discharge through a steam vent opening 48 formed in the rear wall 16f of the cooking compartment 16.

A principal feature of the present invention is an automatic water fill system 73 that includes a water supply line 74 with an outlet 74a, a solenoid valve 76 mounted in the line 74, and control signal lines 78 and 80 to the valve 76 connected to a door switch 15 and a water-level-sensing switch 82, respectively. The switch 82 senses the water level in a box 83 mounted exterior to the cooking compartment 16.

The ultimate water supply (WS) can be a water pipe in a building fed by a municipal water supply at normal “cold” water temperature. Alternatively, it can be a local supply of low mineral content water to minimize scaling, or to a filter unit that in turn is connected to municipal water. The water supply line 74 is preferably a conventional hose connected between this supply WS and the cooking compartment 16. The line 74 also includes a check valve 74b that precedes the solenoid valve 76. The supply line passes through rear walls 12f, 16f as shown, or includes a fitting passing through these walls. The supply line outlet 74a is preferably located just above the floor 16a of the cooking compartment 16 and in the water well 32. A vertical height of about 1½ inch. is typical.

The solenoid valve 76 opens and closes the water feed. When it is open, water flows through the line 74 to add water to the supply 22. When the valve is closed, no water flows. The valve 76 is normally closed. To open, there must be “OPEN” signals applied to the valve 76 on both lines 78 and 80. Line 78 carries an “OPEN” signal to the valve 76 when the door switch 15 is in a state (open or closed) indicative of the doors being open. Line 80 carries an “OPEN” signal to valve 76 when level-sensing switch 82 is in a position corresponding to a low water level of supply 22, typically set to reflect any non-trivial water usage (e.g. 8 fluid ounces, or more for a two-gallon supply). The switch 82 will continue to produce an “OPEN” signal until the water level in the generator rises to a preset “FULL” level 22a. The switch 82 then signals “CLOSE”, and valve 76 closes, and operation of the cooker 10 begins, or continues.

The switch 82 is preferably an electric float switch of conventional design mounted on the exterior of side wall of the float box 83, which in turn is mounted to, or near, the exterior side wall 16e of the cooking compartment. The box has a gravity feed line 83a that places it in fluid communication with the water supply 22 in the cooking compartment. The water level in the box 83 is therefore the same as the water level of the supply 22 in the cooking compartment. Lines 83b and 83c are a breather line and a drain line, respectively for the box 83. Line 83b leads back to the compartment 16. Line 83c branches into drain 24, which may in turn branch into line 54. The switch 82 is preset so that when its float is at a preselected position corresponding to a “full”, or a lower “fill” level, corresponding “CLOSE” or “OPEN” signals are produced by the switch over line 82. Note, when the door 14 is closed, the automatic fill system is disabled. The valve 76 will remain closed even if there is an “OPEN” signal on line 80 from the level-sensing switch 82. Water is therefore added, typically, when the door is opened to load pans to begin cooking, or shortly thereafter to remove one or more pans of cooked food, stir or otherwise prepare the food, or remove servings of cooked food. In each instance where the door is open, the operator can observe the water level and the outlet of the water supply line. The solenoid valve 76, while shown schematically to the rear of the steam cooker 10 in FIG. 4, is preferably mounted to its side, on the box 83.

The door switch 15 can be any conventional ON/OFF microswitch or magnetic switch that is activated by a door opening or closing.

The initial water supply will be about the same, e.g. about 2 gallons, regardless of the size of the cooking cavity, for example, one containing three or five standard sized cooking pans. The pans are typically 1 foot wide by 20 inches long by 2½ inches or 4 inches deep. The steam cooker 10, in the counter-top model shown in FIGS. 1-5, includes a drain pan 26 slideably mounted beneath the housing outer floor 12a to collect condensate.

As shown, the cooker has four legs 28 which provide a clearance for the drain pan 26 compatible with countertop or stand mounting of the cooker (providing convenient chest-height access to the cooking cavity). A typical height for the legs is 4 inches. A typical size for a three-pan capacity steamer 10 is a overall external width of about 2 feet, a depth of about 2½ feet from front to back, and a height of approximately 25½ inches, including the legs from top to bottom for a three-pan capacity. For a five-pan capacity steamer, a typical height is 32 inches. The cooker 10 is therefore relatively compact.

It will be understood that the water 22 is preferably a low-mineral-content water to minimize the scaling that is produced by boiling. However, a direct connection to a conventional water system is convenient and can be used, albeit with increased frequency of cleaning to remove mineral deposits left by the steam generation. The “FULL” water level 22a in the cooker 10 immerses completely a plate-like heating element 30. There is good heat transfer, and an acceptable amount of scaling accumulates during a day of operation (use of about 8 to 12 gallons of water.) This compares extremely favorably with typical condensed water outlet rates of 60 to 70 gallons per hour, and hundreds of gallons per day, for conventional connected cookers. In addition, cleaning to remove and control the build-up of scaling is much easier and much faster than with connected conventional steam cookers. Wiping the heating element with a vinegar solution at the end of the operating day is usually sufficient when low mineral content water is used.

With a maximum supply of water 22 in the well 32, the water level is at a “full” or maximum 22a (shown in dashed line in FIGS. 1, 4, 5 and 7). This level is sufficient to hold a supply of water which will sustain cooking for several hours of normal cooking and warming operations. However, as noted above, the water supply is replenished when the water level falls to a preselected low level, and the door 14 is opened. If the water beeper level should fall to level 22b, where the water level no longer completely immerses the heating element, then an audible signal, e.g. sounding of beeper 43 on the control panel 36, indicates that the operator should open the door to replenish the water supply.

The plate-like heating element 30 is tilted along a diagonal, that is, downwardly both in a back-to-front and side-to-side directions, to thereby produce an elevated corner 30a and a lowered corner 30b diametrically opposite from one another. Heat sensors 34a, 34b, e.g., of the snap-disc type, are secured to the heating element, preferably at the underside as shown. These sensors are preset to generate an electrical output signal when the sensed temperature of the adjacent portion of the heating element rises above a preselected set temperature. The elevated corner 30a and its associated sensor 34a are set at a lower temperature, e.g., 320° F., to provide a primary, automatic reset, sensing for a lower water condition within the cooker 10. If sensor 34a were to fail, and the water level continues to fall, then sensor 34b will open on temperature rise. The sensor 34b is set to produce an output signal at a further elevated temperature, e.g., 375° F., to provide a secondary low-water condition signal which requires a manual reset. Both sensors 34a and 34b can trigger the beeper 43 on a control panel 36 at the right front of the cooker 10, or other alarm such as a warning light and/or can interrupt the supply of power to the heating element through a suitable conventional control circuit mounted on electrical control board 40.

The heating element 30 is preferably formed in the general configuration shown of cast aluminum with electrical resistance heating members imbedded therein. Its exterior surfaces are preferably nickel-plated. Projecting from its lower periphery are a set of threaded mounting studs 38 which engage suitable mating openings formed in a mounting flange forming a portion of the lower wall 16a of the cooking compartment. The heating element is sealed to this mounting flange with a suitable gasket, preferably a one-piece rubber gasket with suitable heat-resistance and sealing qualities for the given operating environment. This use of an tilt-mounted heating element and associated temperature sensors to detect water level in connection with a steam cooker provides a high degree of reliability for the low water detection system.

The cooker 10 can be connected to any standard electrical outlet found in commercial cooking establishments, e.g., one supplying 208, 220, and up to 480 volts of either one or three-phase electrical power. This power is supplied under the control of the electrical control circuitry 40 mounted internal to the cooker 10 to the electrical resistance heating elements 30. The power supply is initiated by an external manual ON/OFF control switch 42 on the front control panel 36. The control circuitry 40 includes the ability through a selector switch 44, also on the control panel 36, to provide full-power operation, e.g., 6 or 9 kilowatts for a three or five-pan cooker 10, respectively, or a low-power (power conservation) setting to supply either 4 or 6 kilowatts of maximum power input for the same three or five-pan sized cookers 10, respectively. The control panel 36 also has an external timer 45 that has a “HOLD” position where energization of the heater is under the control of a hold thermostat 72 mounted on the outside of wall 16e. The thermostat 72, e.g., of the snap-disk type, is preset at a desired “hold” temperature associated with normal operations.

Another feature of the present invention is a temperature and pressure control system, designated generally by the reference numeral 46, that provides close control over the pressure of the steam within the cooking cavity during normal operation, and which also has the added advantage of rapidly evacuating cold air from the cooking chamber to conserve power, enhance the speed of operation, and provide a stable, uniform temperature and pressure gradient within the cooking cavity. The cold air evacuation features of the system 46 are also utilized in combination with other components of the pressure-regulating system, as described below, to provide overpressure relief.

The system 46 includes the steam vent opening 48 formed in the rear wall 16f at a point in the lower half of the cooking cavity 16, and preferably at or closely spaced above the high water level 22a. This location ensures that as steam is generated and rises within the cavity, the trapped cold air within the cavity when the door is closed is forced downwardly to a region adjacent the vent opening 48 where it can exit. Immediately adjacent this vent opening is a solenoid valve 50, which can be best seen in FIG. 3. The vent 48 feeds branched outlets 51a and 51b in direct fluid communication with the steam vent port opening 48. Outlet branch 51a directs the vented fluids to the solenoid valve 50 which is electrically actuated to close from a normally open position in response to the presence or absence of an output signal from a thermostat 52 (best seen in FIG. 1).

In its normally open position, the valve 50 is a low-resistance flow path from the cooking chamber, via vent 48, to atmosphere, via the valve outlet drain port 50c. A drain conduit 54 directs the outlet steam, condensed water, and any solid matter carried by the steam or water to the drain pan 26 via a drain port 56. This port is formed in the housing floor 12a, but at a point exterior to a rear wall 16f of the cooking compartment which holds the water 22 in the water well 32 inside the cooking compartment. The thermostat 52 is located in a lower portion of the steam compartment, and preferably, as shown, closely spaced from the steam vent opening 48 and at generally the same horizontal level as the steam vent opening 48. Both are preferably slightly above the high water level 22a within the cooking compartment. This location and relationship with respect to the steam vent opening allows the thermostat to sense the temperature of the vapor at the outlet port, particularly during the preheat cycle after the steam cooker is first powered. As noted above, during this preheat period the generation of steam drives cold air to the outlet port. The thermostat 52 senses the temperature of this air and then its increasing temperature. The thermostat is set at a preselected temperature just below that of the boiling point of water, and with a tight tolerance (a typical value being 200° F.±7° F.). When this temperature is sensed, the thermostat generates an output signal which is applied to the solenoid valve 50 over line 53, causing the valve to close. The thermostat and solenoid valve so positioned form a reliable and accurately responsive electric steam trap that rapidly evacuate cold air from the heating chamber during the preheat period, and then retain to a high degree the steam that is generated.

In its closed position, the solenoid valve 50 blocks an outlet flow via branch 51a in favor of branch 51b. Steam exiting the cooking compartment via the steam vent opening 48 and branch 51b is in fluid communication with a conduit 58. This conduit has branches 58a and 58b that in turn are in fluid communication with miniature pressure switches 60 and 62, respectively, mounted on the upper outer surface of the rear wall 16f of the cooker 10. The microswitch 60 cycles between ON and OFF positions in response to a sensed water column (W.C.) pressure of the steam at the outlet vent port 48, as conducted via conduit 58, to regulate the application of electrical power to the heating element 30 (whether at a high or low setting set by the selector switch 44). The preselected set points for operation of the switch 60 maintain the steam pressure for cooking or warming within a closely-controlled range. A typical value for this range is 1 to 3 inches of water column pressure, which is about equivalent to blowing bubbles through a straw immersed in a glass of water. If the water column pressure falls below 1 inch, the switch 60 closes, which applies electrical power to the heating element. If the switch 60 senses a pressure of 3 inches W.C. or more, it opens to interrupt the supply of power to the heating element 30.

Simultaneously, the conduit branch 58b directs the same sensed outlet steam pressure to a second miniature pressure microswitch 62 which is set at a higher set point, e.g., 9 inches of W.C. pressure. The switch 62 is preset to open on rise at this preset value to send an output signal over line 63 to operate the solenoid valve 50, causing it to open. This rapidly dissipates any unsafe pressures that may develop within the cooking compartment.

The microswitch 62, in addition to providing overpressure protection, also assists in responding to sudden pressure fluctuations associated with opening the door 14 or closing it, particularly a slam closing. A pressure spike that is sensed at more than the preselected set pressure of the switch 62, e.g., 9 inches W.C., will generate a signal that opens the solenoid valve 50 to dissipate the pressure spike. When the pressure spike dissipates, the switch then rapidly closes the solenoid valve 50, and the switch 60 resumes control of the pressure regulation within the cooking cavity. In addition, if any significant amount of cold air has entered the cooking cavity while the door is open, then the thermostat 52 will sense the accumulation of cold air at the bottom of the cooking compartment and may, depending on whether or not the temperature has fallen sufficiently low, also open the valve 50 to vent the cold air.

The system 46 also includes a check valve 64 in fluid communication with the conduit 68b and branch 51b such that should the valve 50 remain in the closed position in an overpressure situation, the check valve will open, causing a venting of the overpressure to atmosphere directly through the solenoid valve 50 and the check valve 64 and drain line 68 to a drain port 70. For the illustrative pressure values given hereinabove as typical, the check valve has a preset trip pressure of ½ psi (pounds per square inch). The temperature and pressure control system 46 as described provides rapid, efficient, and well-controlled heating of the cooking compartment while also providing a high degree of safety. In addition, all of the components of the system 46 are conventional components and they are readily accessible for inspection and/or maintenance.

It should be noted that the cooker also includes a small bleed vent orifice 66 formed in the rear wall 16f of the cooking compartment which feeds a branch 68a of a drain conduit 68. The branch 68b of the conduit 68 connects the outlet of the check valve 64 to the port 70. The bleed orifice is very small to retain most of the steam within the cooking compartment while allowing a small bleed-off of the steam to keep the steam moving and “live” within the cooking compartment. A typical diameter of the orifice is in the range of 0.08 to 0.09 inch.

Given the large surface area of the heating element 30, and given the wattages of electrical power applied to the heating element, it will be evident to those skilled in the art that the heating element 30 has a comparatively low wattage density. This is important in controlling possible damage to the heating element through thermal shock, as comparatively cold water is added to the water well to replenish the supply while the heating element is still hot.

The steam cooker 10 as described above thus provides all of the known advantages of connectionless cooking while at the same time providing the automatic water-fill convenience of a connected steam cooker. The steam cooker 10 also improves the efficiency, reliability and safety of connectionless cooking operation, as well as providing ease in cleaning and routine maintenance, particularly accessibility to the heating elements and interior surfaces where deliming or cooking residue removal is required. The control system provide a close degree of control over the operating conditions within the cooking cavity, including pressure spikes associated with opening and closing the access door, and the problem of eliminating cold air which is present initially in the cooking compartment and may be added as the door is opened to gain access to the food being cooked. The present invention offers good power usage and water usage characteristics.

FIGS. 6 and 7 show an alternative “stand-up” embodiment of the present invention where two atmospheric steam cookers 10′ are housed in a stacked relationship in a single cabinet or housing 12′ to provide a multiple oven cooker of the same general size and cooking capacity as the aforementioned connected “STEAM TECH PLUS”® cooker utilizing the Kolvites '033 and '038 inventions. (Like parts in different embodiments are identified with the same reference number, but distinguished with a prime (′)).

Each steam cooker 10′ is permanently connected to a water supply line 74′ with an associated check valve 74b and flow control valve 76′. Operation of each valve 76′ to open from its normally closed position, is under the associated door switch 15′ and water-level-sensing switch 82′ operating in conjunction with a float box 83′. Each cooker 10′ also has an associated temperature and pressure regulation system 46′ utilizing, among other components, a temperature responsive valve 50′ and branched pressure regulators 58a′, 58b′, 60′ and 62′. Each cooker 10′ also has a water supply 22′ and heater 30′ immersed in the water and forming a generator internal to the cooker, within the cooking compartment 16′.

In the FIGS. 6 and 7 embodiment, one difference from the FIGS. 1-5 embodiment is that in the presently preferred form shown, each cooking compartment s 16′ regulation system 46′, and float switch box 83″ all drain via lines 24′, 54′, 68′, and 83c′ to a common drain line 83 that terminates in a water management tank 84 located below the cooker 10′. This steam cooker, with the water management tank 84, has the versatility of operating either in a water and power saving mode, as described, or in a rapid cook, constant steam production mode similar to that of the STEAM TECH PLUS® connected cooker. To select the constant steam mode, a selector switch is set to “constant steam” or “rapid cook”. It is anticipated that it will be sufficient if this selection disables (switches out) the temperature controls on the thermostatic valve, with the water-column pressure regulator left in its normal operating condition. Like results may be achieved by adjusting the thermostat set points to levels conducive to delivery of sufficient power to the heater for sufficient intervals, to maintain the water supply in a steam-generating condition. This results in more water usage, more power consumption, and a hotter effluent, but provides more rapid cooking for peak periods, or when speed of cooking is otherwise paramount. The rapid cook mode of operation has an increased power usage, e.g. 12 kw per compartment 16′ for cooking and 9 kw for warming.

The tank 84 holds a supply, e.g. 2 gallons, of water at a temperature well below that of condensed water draining from an oven in use. Thus, escaped steam, hot condensed water, and the scale and food debris carried with them, mix with the water held in the tank 84. This cools the effluents so that they can be discharged, e.g. by a simple overflow drain 84a, or valved drain conduit, to a public sewer drain line or an equivalent. The tank has a vent line 86 that extends up the rear of the cabinet 12′, and an internal wier 88 that divides the tank into two volumes while allowing a limited flow under the wier between the volumes. The volume of the water supply is such that it reliably maintains any discharge to a temperature of 140° F., or less. The tank 84 also provides the other advantages of the tempering tank 13 described in the Kolvites '033 and '038 patents.

While the invention has been described with respect to its present preferred embodiments, it will be understood by those skilled in the art that various modifications and alterations will occur from reading the foregoing specification in light of the accompanying drawings. For example, while the invention has been described in connection with FIGS. 1-5 with respect to a system utilizing a drain pan, the drains 24, 54, and 64 can be permanently connected to a drain line, or to a water management tank as discussed in connection with FIGS. 6 and 7. Further, the system 46 could be utilized in conjunction with other known heating elements, e.g. gas-fired, and other known water level control arrangements. Also, the particular configuration of the interconnections of the components forming the temperature and control system 46 can assume a variety of forms and utilize components a variety of sizes and manufacturing types, provided that they operate in conformity with the operating principles described hereinabove. For example, the thermostat and steam vent port may be located farther apart, or at less than a precise horizontal alignment, or at a point raised farther above the maximum water level 22a, but all with associated reductions in the faithfulness with which the system senses the actual temperature and pressure within the cooking compartment, particularly at its lowest point, and therefore less faithfully controls the operating parameters within the cooking compartment to the desired optimal levels.

With respect to the automatic fill system, the form of the level-sensing switch can take a variety of forms, such as a ball or bayonet-type electric float switch, or even a non-electric float switch—as in the flush toilet—where a float position has a direct mechanical interaction with, and control over the operation of, a water flow valve. The level detector can also be located inside the oven and operate on different principles than a float. However, this location is more susceptible to unreliable performance due to the adverse conditions in the cooking environment noted above, and due to failures to meet cleaning and maintenance requirements.

Further, while the invention has been described with two ovens in the FIGS. 6 and 7 embodiments, a water management system and a constant steam operating mode option are available for a single oven, or for more than two ovens housed in a single unit.

While the invention has been described in connection with internal generators to provide the advantages of connectionless steam cooking, it is possible to use the temperature and pressure regulation features of the system 46 with external generators. The regulation system 46 is in communication with the lower half of the cooking compartment, and preferably near the floor. The automatic fill features described above can also be used independently of the regulation features, and with external as well as internal generators. However, the efficiency, convenience, and reliability of this invention is most pronounced when the regulation, refill, and internal generator features are used in combination, as described and illustrated herein. These and other modifications are intended to fall within the scope of the appended claims.

What is claimed is:

1. A steam cooker comprising:
A) a cooking compartment that is accessible through a door,
B) a supply of water and a heating element disposed to heat said water supply to produce steam in said cooking compartment,
C) a steam outlet formed in said housing and in fluid communication with the interior of said cooking compartment, and
D) an automatic electric steam trap connected to said vapor outlet, said steam trap being normally open to the atmosphere, and closing when the temperature of the steam in the cooking cavity measured adjacent said steam outlet is at or over a preselected operating temperature.

2. The steam cooker of claim 1 wherein said electric steam trap comprises a temperature sensor mounted in said housing to sense the temperature of said steam in said cavity, and a normally-open solenoid valve that is open to atmosphere.

3. The steam cooker of claim 2 wherein said temperature sensor and said solenoid valve are adjacent one another and said vapor outlet.

4. The connectionless steamer according to any of the foregoing claims wherein said steam outlet is located in the lower half of said cooking compartment, and further comprising a controller for the operation of said heating element, said controller being responsive to the steam pressure at said steam outlet.

5. The steam cooker of claim 4 wherein said controller comprises a first water-column-pressure (WC)-actuated microswitch operatively coupled via a first conduit to said steam pressure at said steam outlet and set to control the degree of energization of said heating element to maintain said steam pressure within said cooking compartment within a closely-controlled operating range.

6. The steam cooker of claim 5 wherein said controller further includes a second water-column-pressure (WC)-actuated microswitch operatively coupled via said first conduit to the steam pressure at said steam outlet, but operable to produce an output control signal at a set pressure in excess of said closely-controlled range of pressures.

7. The steam cooker of claim 6 wherein said operative coupling includes a branched conduit in fluid communication between said steam outlet and said first and second microswitches.

8. The steam cooker of claim 1 wherein said heating element has a generally plate-like configuration and is immersed in said supply of water with a tilt from the horizontal, and further comprising temperature-sensing members disposed at raised and lowered ends of said tilt-mounted heater plate an set to produce an output signal when the sensed heater temperature rises to a level indicative of the absence of water at the adjacent portion of said heating plate.

9. A steam cooker comprising:
A) a cooking compartment that is accessible through a door,
B) a steam generator having a supply of water and a heating element disposed, when energized, to heat said water supply to produce steam in said cooking compartment,
C) a conduit connected to feed water from a water source to said water supply,
D) a normally-closed valve connected in line with said conduit to control the flow of said fed water, and
E) a control for said valve that places said normally closed valve when both said door is open and said water supply level is below a preset value.

10. The steam cooker of claim 9 wherein said control has a door sensor that produces a valve control signal when said door is open, and a water level sensor that produces a valve-open control signal when it senses that the water level is below said preset level.

11. The steam cooker of claim 10 wherein said water supply and said heating element of said steam generator are located in said compartment, and the level of said water supply and said water feed are observable when said door is open.

12. The steam cooker of claim 10 wherein said water level sensor is a float switch in fluid communication with said water supply.

13. The steam cooker of claim 12 wherein said float switch is electric.

14. The steam cooker of any of claims 9-13, further comprising:
a steam outlet formed in said housing and in fluid communication with the interior of said cooking compartment in a lower half thereof, and
an automatic electric steam trap connected to said vapor outlet, said steam trap being normally open to the atmosphere, and closing when the temperature of the steam in the cooking cavity measured adjacent said steam outlet is at or over a preselected operating temperature.

15. The steam cooker of claim 14 wherein said electric steam trap comprises a temperature sensor mounted in said housing to sense the temperature of said steam in said cavity, and a normally-open solenoid valve that is open to atmosphere.

16. The steam cooker of claim 15 wherein said temperature sensor and said solenoid valve are adjacent one another and said vapor outlet.

17. The steam cooker of claim 14, further comprising a controller for the operation of said heating element, said controller being responsive to the steam pressure at said steam outlet.

18. The steam cooker of claim 17 wherein said controller comprises a first water-column-pressure (WC)-actuated microswitch operatively coupled via a first conduit to said steam pressure at said steam outlet and set to control the degree of energization of said heating element to maintain said steam pressure within said cooking compartment within a closely-controlled operating range.

19. The steam cooker of claim 18 wherein said controller further includes a second water-column-pressure (WC)-actuated microswitch operatively coupled via said first conduit to the steam pressure at said steam outlet, but operable to produce an output control signal at a set pressure in excess of said closely-controlled range of pressures.

20. The steam cooker of claim 19 wherein said operative coupling includes a branched conduit in fluid communication between said steam outlet and said first and second microswitches.

21. The steam cooker of claim 14 wherein said heating element has a generally plate-like configuration and is immersed in said supply of water with a tilt from the horizontal, and further comprising temperature-sensing members disposed at raised and lowered ends of said tilt-mounted heater plate an set to produce an output signal when the sensed heater temperature rises to a level indicative of the absence of water at the adjacent portion of said heating plate.

22. A steam cooker comprising:
A) a cooking compartment that is accessible through a door mounted on the housing,
B) a steam generator having a supply of water and a heating element disposed, when energized, to heat said water supply to produce steam in said cooking compartment,
C) a conduit connected to feed water from a water source to said water supply on demand,
D) a normal—closed valve connected in line with said conduit to control the flow of said fed water,
E) a control for said valve that places said normally closed valve when both said door is open and said water supply level is below a preset value;
F) a steam outlet formed in said housing and in fluid communication with the interior of said cooking compartment in a lower half thereof, and an automatic electric steam trap connected to said vapor outlet, said steam trap being normally open to the atmosphere, and closing when the temperature of the steam in the cooking cavity measured adjacent said steam outlet is at or over a preselected operating temperature,
G) wherein plural of said foregoing elements A-F are mounted in a common housing, each having at least one fluid outlet for steam, condensed water, and cooking residue carried by the steam and condensed water, further comprising
H) a water management tank that receives said outlet fluids from said steam cookers.

23. The steam cooker of claim 22 wherein said water management tank holds a second supply of water that cools said outlet fluids.

24. The steam cooker of claim 23 further comprising a weir that separates said second water supply into a portion that receives said outlet fluids directly and a portion isolated by said water from said first portion and accessible to a drain.
